(19) United States
(12) Patent Application Publication
(10) Pub. No.: US 2009/0311478 A1
(43) Pub. Date: Dec. 17, 2009

(54) MULTI-PLY FIBROUS STRUCTURES AND METHODS FOR MAKING SAME

(76) Inventors: Matthew Fredrick Ehlerding, Sharonville, OH (US); Guillermo Mitias Vidal, Cincinnati, OH (US); Luis Bernando de la Rosa, Mason, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/482,505

(22) Filed: Jun. 11, 2009

Related U.S. Application Data
(60) Provisional application No. 61/061,135, filed on Jun. 13, 2008.

(51) Int. Cl. B32B 3/10; B32B 29/02; D21F 11/00

(52) U.S. Cl. 428/152; 428/534; 162/123

(57) ABSTRACT

Multi-ply fibrous structures and more particularly to multi-ply fibrous structures that employ fibrous structure plies that contain different fiber compositions and methods for making such multi-ply fibrous structures are provided.

### CROSS REFERENCE TO RELATED APPLICATION(S)

This application claims the benefit of U.S. Provisional Application No. 61/061,135, filed Jun. 13, 2008.

### FIELD OF THE INVENTION

The present invention relates to multi-ply fibrous structures and more particularly to multi-ply fibrous structures that comprise fibrous structure plies that contain different fiber compositions and methods for making such multi-ply fibrous structures.

### BACKGROUND OF THE INVENTION

Traditionally, multi-ply fibrous structures have been made by combining two or more plies of fibrous structure that comprise essentially the same fiber composition. For example, Charmin® brand toilet paper in Mexico comprises two plies of fibrous structure that contain similar levels and types of virgin fibers and recycled fibers.

With the ever increasing price of pulp, formulators have been exploring ways to manage the increased cost of pulp without jeopardizing properties of fibrous structures.

Accordingly, there is a need for a multi-ply fibrous structure that cost effectively utilizes pulp without negatively impacting properties of the multi-ply fibrous structure and method for making same.

### SUMMARY OF THE INVENTION

The present invention fulfills the needs described above by providing a multi-ply fibrous structure that comprises plies that contain different fiber compositions and method for making such multi-ply fibrous structures.

In one example, a multi-ply fibrous structure comprising a first ply and a second ply, wherein the first ply comprises a first fiber composition comprising from 60%-100% by weight on a dry fiber basis of virgin fibers and from 0%-40% by weight on a dry fiber basis of recycled fiber; and the second ply comprises a second fiber composition comprising from 0%-35% by weight on a dry fiber basis of virgin fibers and from 65% to 100% by weight on a dry fiber basis of recycled fibers, is provided.

In another example of the present invention, a multi-ply sanitary tissue product comprising a multi-ply fibrous structure according to the present invention is provided.

In yet another example of the present invention, a method for making a multi-ply fibrous structure comprising the steps of:

a. providing a first fiber slurry comprising a first fiber composition comprising from 60%-100% by weight on a dry fiber basis of virgin fibers and from 0%-40% by weight on a dry fiber basis of recycled fiber;

b. producing a first ply comprising the first slurry;

c. providing a second fiber slurry comprising a second fiber composition comprising from 0%-35% by weight on a dry fiber basis of virgin fibers and from 65% to 100% by weight on a dry fiber basis of recycled fibers;

d. producing a second ply comprising the second fiber slurry; and

e. combining the first and second ply to produce a multi-ply fibrous structure, is provided.

Accordingly, the present invention provides a multi-ply fibrous structure, multi-ply sanitary tissue product employing same and method for making same.

### DETAILED DESCRIPTION OF THE INVENTION

### Definitions

“Fiber” as used herein means an elongate particulate having an apparent length greatly exceeding its apparent width, i.e. a length to diameter ratio of at least about 10. Fibers have some integrity, i.e. manifested by some intrinsic strength. If an apparent elongate particulate, supported by a substrate, fails to have enough instrinsic strength to support itself, it is not a fiber, but may be a faux fiber. More specifically, as used herein, “fiber” refers to papermaking fibers. The present invention contemplates the use of a variety of papermaking fibers, such as, for example, natural fibers or synthetic fibers, or any other suitable fibers, and any combination thereof. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking.

In addition to the various wood pulp fibers, other cellulosic fibers such as cotton linters, rayon, and bagasse can be used in this invention. Synthetic fibers and/or non-naturally occurring fibers, such as polymeric fibers including natural polymeric fibers such as starch and/or modified starch polymeric fibers, can also be used. Elastomeric polymers, polypropylene, polyethylene, polyester, polyolefin, and nylon, can be used. The polymeric fibers can be produced by spunbond processes, meltblown processes, and other suitable methods known in the art.

An embryonic fibrous web can be typically prepared from an aqueous dispersion of papermaking fibers, though dispersions in liquids other than water can be used. The fibers are dispersed in the carrier liquid to have a consistency of from about 0.1 to about 0.3 percent. It is believed that the present invention can also be applicable to moist forming operations where the fibers are dispersed in a carrier liquid to have a consistency of less than about 50% and/or less than about 10%.

“Virgin fiber” as used herein means a fiber that is yielded from a process where the cellulose fibers have been chemically and/or mechanically derived directly from an agricultural source and/or wood source, such as raw wood, and have not been derived from post-consumer waste in any form.

“Recycled fiber” as used herein means a fiber that is derived from post-consumer waste, such as office waste, book stock, newspapers, magazines, posters, packaging, etc. In one example, for recycled fibers to be rendered into a usable fiber for tissue papermaking, it must undergo a process, such as de-inking, to biologically, chemically and/or mechanically remove binders, fillers, inks, coatings and/or other extraneous materials to yield raw cellulose fibers. Recycled fibers are typically classified according to different grades. Lower fiber grades contain fewer long fibers and/or more short fibers, particularly lignin fibers and fines. In lower grades of recycled fibers, the short fiber length, high composition of fines, and high fibrillations of individual fibers are also often due multiple passes through deinking, pulping, and papermaking processes over its life. In other words, the fiber has been used multiple times in the manufacturing processes of various products. The more times it has passed through these processes and re-used, the more damaged the fiber becomes, including fiber cutting and high fibrillations. For example, recycled fibers from the U.S. typically are of a better grade (higher quality) than recycled fibers from Mexico. The grade differences typically result from how vigorous and/or the number of times the recycled fibers are treated, such as deinked and other cleanup processes known in the art. In addition, the types of fibers that compose the recycled fibers also impact the grade of the recycled fibers. For example, whether the recycled fibers comprise newsprint, books, and the like.

“Fibrous structure” as used herein means a structure that comprises one or more fibers. In one example, a fibrous structure according to the present invention means an orderly arrangement of fibers within a structure in order to perform a function. Nonlimiting examples of fibrous structures of the present invention include composite materials (including reinforced plastics and reinforced cement), paper, fabrics (including woven, knitted, and non-woven), and absorbent pads (for example for diapers or feminine hygiene products). A bag of loose fibers is not a fibrous structure in accordance with the present invention.

Nonlimiting examples of processes for making fibrous structures include known wet-laid papermaking processes and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous suspension is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

The fibrous structures of the present invention may be homogeneous or may be layered. If layered, the fibrous structures may comprise at least two and/or at least three and/or at least four and/or at least five layers.

The fibrous structures of the present invention may be co-formed fibrous structures.

“Sanitary tissue product” as used herein means a soft, low density (i.e. <about 0.15 g/cm3) web useful as a wiping implement for post-urinary and post-bowel movement cleaning (toilet tissue), for otorhinolaryngological discharges (facial tissue), and multi-functional absorbent and cleaning uses (absorbent towels). The sanitary tissue product may be convolutedly wound upon itself about a core or without a core to form a sanitary tissue product roll.

In one example, the sanitary tissue product of the present invention comprises a fibrous structure according to the present invention.

In one example, the sanitary tissue product of the present invention is a 2-ply sanitary tissue product comprising two fibrous structures according to the present invention.

The sanitary tissue products of the present invention may exhibit a basis weight between about 10 g/m² to about 120 g/m² and/or from about 15 g/m² to about 110 g/m² and/or from about 20 g/m² to about 100 g/m² and/or from about 30 to 90 g/m². In addition, the sanitary tissue product of the present invention may exhibit a basis weight between about 40 g/m² to about 120 g/m² and/or from about 50 g/m² to about 110 g/m² and/or from about 55 g/m² to about 105 g/m² and/or from about 60 to 100 g/m².

The sanitary tissue products of the present invention may exhibit a total dry tensile strength of greater than about 59 g/cm (150 g/in) and/or from about 78 g/cm (200 g/in) to about 394 g/cm (1000 g/in) and/or from about 98 g/cm (250 g/in) to about 335 g/cm (850 g/in). In addition, the sanitary tissue product of the present invention may exhibit a total dry tensile strength of greater than about 196 g/cm (500 g/in) and/or from about 196 g/cm (500 g/in) to about 394 g/cm (1000 g/in) and/or from about 216 g/cm (550 g/in) to about 335 g/cm (850 g/in) and/or from about 236 g/cm (600 g/in) to about 315 g/cm (800 g/in). In one example, the sanitary tissue product exhibits a total dry tensile strength of less than about 394 g/cm (1000 g/in) and/or less than about 335 g/cm (850 g/in).

In another example, the sanitary tissue products of the present invention may exhibit a total dry tensile strength of greater than about 315 g/cm (800 g/in) and/or greater than about 354 g/cm (900 g/in) and/or greater than about 394 g/cm (1000 g/in) and/or from about 315 g/cm (800 g/in) to about 1968 g/cm (5000 g/in) and/or from about 354 g/cm (900 g/in) to about 1181 g/cm (3000 g/in) and/or from about 354 g/cm (900 g/in) to about 984 g/cm (2500 g/in) and/or from about 394 g/cm (1000 g/in) to about 787 g/cm (2000 g/in).

The sanitary tissue products of the present invention may exhibit a total wet tensile strength of less than about 78 g/cm (200 g/in) and/or less than about 59 g/cm (150 g/in) and/or less than about 39 g/cm (100 g/in) and/or less than about 29 g/cm (75 g/in).

The sanitary tissue products of the present invention may exhibit a density of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

The sanitary tissue product rolls of the present invention may comprise a plurality of connected, but perforated sheets, that are separably dispensable from adjacent sheets.

The sanitary tissue products of the present invention may comprises additives such as softening agents, temporary wet strength agents, permanent wet strength agents, bulk softening agents, lotions, silicones, and other types of additives suitable for inclusion in and/or on sanitary tissue products.

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

“Basis Weight” as used herein is the weight per unit area of a sample reported in lbs/3000 ft² or g/m². Basis weight is measured by preparing one or more samples of a certain area (m²) and weighing the sample(s) of a fibrous structure according to the present invention and/or a paper product comprising such fibrous structure on a top loading balance with a minimum resolution of 0.01 g. The balance is protected from air drafts and other disturbances using a draft shield. Weights are recorded when the readings on the balance become constant. The average weight (g) is calculated and the average area of the samples (m²). The basis weight (g/m²) is calculated by dividing the average weight (g) by the average area of the samples (m²).

“Machine Direction” or “MD” as used herein means the direction parallel to the flow of the fibrous structure through the papermaking machine and/or product manufacturing equipment.

“Cross Machine Direction” or “CD” as used herein means the direction perpendicular to the machine direction in the same plane of the fibrous structure and/or paper product comprising the fibrous structure.

“Ply” or “Plies” as used herein means an individual fibrous structure optionally to be disposed in a substantially contiguous, face-to-face relationship with other plies, forming a multiple ply fibrous structure.

As used herein, the articles “a” and “an” when used herein, for example, “an anionic surfactant” or “a fiber” is understood to mean one or more of the material that is claimed or described.

All percentages and ratios are calculated by weight unless otherwise indicated. All percentages and ratios are calculated based on the total composition unless otherwise indicated.

Unless otherwise noted, all component or composition levels are in reference to the active level of that component or composition, and are exclusive of impurities, for example, residual solvents or by-products, which may be present in commercially available sources.

### Fiber Compositions

A fibrous structure of the present invention may comprise a fiber composition comprising from 60% to about 100% by weight on a dry fiber basis of virgin fibers and from 0% to about 40% by weight on a dry fiber basis of recycled fiber. In another example, the fiber composition may comprise greater than 70% by weight on a dry fiber basis of virgin fibers. In yet another example, the fiber composition may comprise from about 70% to about 95% by weight on a dry fiber basis of virgin fibers. In one example, the fiber composition may comprise about 100% by weight on a dry fiber basis of virgin fibers. In still another example, the fiber composition may comprise from 0% to about 25% by weight on a dry fiber basis of recycled fibers.

In another example, a fibrous structure of the present invention may comprise a fiber composition comprising from 0% to about 35% by weight on a dry fiber basis of virgin fibers and from 65% to about 100% by weight on a dry fiber basis of recycled fibers. In even another example, the fiber composition may comprise 0% to about 15% by weight on a dry fiber basis of virgin fibers. In even yet another example, the fiber composition may comprise 0% by weight on a dry fiber basis of virgin fibers. In even still another example, the fiber composition may comprise from about 80% to about 100% by weight on a dry fiber basis of recycled fibers. In yet another example, the fiber composition may comprise about 100% by weight on a dry fiber basis of recycled fibers.

The virgin fibers may be selected from the group consisting of: hardwood fibers, softwood fibers and mixtures thereof. The hardwood fibers may be obtained from tropical hardwood and thus are tropical hardwood fibers. Nonlimiting examples of tropical hardwood fibers include eucalyptus fibers, acacia fibers and mixtures thereof.

The recycled fibers may comprise prior virgin fibers that have been treated and reused at least once. Nonlimiting examples of recycled fibers are commercially available from waste yards and/or garbage yards that sort paper waste into various grades known in the industry as office waste, sorted white ledger, manifold white ledger, and coated book stock.

### Fibrous Structure Plies

In one example the multi-ply fibrous structure comprises a first ply comprising a first fiber composition and a second ply comprising a second composition different from the first composition. The first ply may comprise a first fiber composition comprising from 60% to about 100% by weight on a dry fiber basis of virgin fibers and from 0% to about 40% by weight on a dry fiber basis of recycled fiber. The second ply may comprise a second fiber composition comprising from 0% to about 35% by weight on a dry fiber basis of virgin fibers and from 65% to about 100% by weight on a dry fiber basis of recycled fibers.

In another example, the first ply may comprise some aesthetics and/or texture that is different from the second ply. The aesthetics and/or texture of the first ply may be used to communicate to a consumer which side of the multi-ply fibrous structure to bring into contact with the consumer's skin during use such as during wiping. The other side (the second ply) may be held in the consumer's hand and/or the consumer may create an implement such as by folding and/or wadding the multi-ply fibrous structure such that the consumer's hand is also in contact with the first ply. Nonlimiting examples of aesthetics and/or texture include embossments, printing and/or colored plybond glue that is more visible from the first ply side than from the second ply side. By signaling which side of the multi-ply fibrous structure to use, the risk of the consumer using the wrong side, for example the side that has less virgin fibers, is mitigated if not erased entirely.

In another example, the first ply may comprise a first fiber composition that comprises a better grade of recycled fibers than the recycled fibers of the second fiber composition present in the second ply.

At least one of the first and second plies may comprise a layered fibrous structure ply.

One or more of the plies of the multi-ply fibrous structure may comprise a wet-pressed fibrous structure ply. Alternatively or in addition to a wet-pressed fibrous structure ply, one or more of the plies may comprise a through-air-dried fibrous structure ply. In another example, one or more of the plies may comprise a creped fibrous structure ply or an uncreped fibrous structure ply or at least one of each.

### Method for Making Multi-Ply Fibrous Structure

The multi-ply fibrous structure of the present invention may be made by any suitable process known in the art. In one example, the multi-ply fibrous structure of the present invention is made by a method comprising the steps of:

a. providing a first fiber slurry comprising a first fiber composition comprising from 60%-100% by weight on a dry fiber basis of virgin fibers and from 0%-40% by weight on a dry fiber basis of recycled fiber;

b. producing a first ply comprising the first slurry;

c. providing a second fiber slurry comprising a second fiber composition comprising from 0%-35% by weight on a dry fiber basis of virgin fibers and from 65% to 100% by weight on a dry fiber basis of recycled fibers;

d. producing a second ply comprising the second fiber slurry; and

e. combining the first and second ply to produce a multi-ply fibrous structure.

In one example, the first and/or second plies may be creped. In another example, the first and/or second plies may be uncreped. In another example, the first and/or second plies may be wet-pressed. In another example, the first and/or second plies may be through-air-dried. In another example, the first and/or second plies may be embossed.

The combining step of the method may comprise plybonding the first and second plies together via an adhesive.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A multi-ply fibrous structure comprising a first ply and a second ply, wherein the first ply comprises a first fiber composition comprising from 60%-100% by weight on a dry fiber basis of virgin fibers and from 0%-40% by weight on a dry fiber basis of recycled fiber; and the second ply comprises a second fiber composition comprising from 0%-35% by weight on a dry fiber basis of virgin fibers and from 65% to 100% by weight on a dry fiber basis of recycled fibers.

2. The multi-ply fibrous structure according to claim 1 wherein the first fiber composition comprises greater than about 70% by weight on a dry fiber basis of virgin fibers.

3. The multi-ply fibrous structure according to claim 1 wherein the first fiber composition comprises from about 70% to about 95% by weight on a dry fiber basis of virgin fibers.

4. The multi-ply fibrous structure according to claim 1 wherein the second fiber composition comprises 0% to about 15% by weight on a dry fiber basis of virgin fibers.

5. The multi-ply fibrous structure according to claim 1 wherein the second fiber composition comprises 0% by weight on a dry fiber basis of virgin fibers.

6. The multi-ply fibrous structure according to claim 1 wherein the virgin fibers are selected from the group consisting of: hardwood fibers, softwood fibers and mixtures thereof.

7. The multi-ply fibrous structure according to claim 6 wherein the virgin fibers comprise tropical hardwood fibers.

8. The multi-ply fibrous structure according to claim 7 wherein the tropical hardwood fibers are selected from the group consisting of: eucalyptus fibers, acacia fibers and mixtures thereof.

9. The multi-ply fibrous structure according to claim 1 wherein first fiber composition comprises from 0% to about 25% by weight on a dry fiber basis of recycled fibers.

10. The multi-ply fibrous structure according to claim 1 wherein the second fiber composition comprises from 80%-100% by weight on a dry fiber basis of recycled fibers.

11. The multi-ply fibrous structure according to claim 1 wherein the second fiber composition comprises about 100% by weight on a dry fiber basis of recycled fibers.

12. The multi-ply fibrous structure according to claim 1 wherein the recycled fibers are obtained from sources selected from the group consisting of: office waste, book stock, newspapers, magazines, posters, packaging

13. The multi-ply fibrous structure according to claim 1 wherein the first fiber composition comprises a better grade of recycled fibers than the recycled fibers of the second fiber composition.

14. The multi-ply fibrous structure according to claim 1 wherein at least one of the first and second plies comprises a layered fibrous structure ply.

15. The multi-ply fibrous structure according to claim 1 wherein at least one of the first and second plies comprises a wet-pressed fibrous structure ply.

16. The multi-ply fibrous structure according to claim 1 wherein at least one of the first and second plies comprises a through-air-dried fibrous structure ply.

17. The multi-ply fibrous structure according to claim 1 wherein at least one of the first and second plies comprises a creped fibrous structure ply.

18. The multi-ply fibrous structure according to claim 1 wherein at least one of the first and second plies comprises an uncreped fibrous structure ply.

19. The multi-ply fibrous structure according to claim 1 wherein the first ply further comprises aesthetics and/or texture that is different from the second ply.

20. A multi-ply sanitary tissue product comprising a multi-ply fibrous structure according to claim 1.

21. A method for making a multi-ply fibrous structure comprising the steps of:
a. providing a first fiber slurry comprising a first fiber composition comprising from 60%-100% by weight on a dry fiber basis of virgin fibers and from 0%-40% by weight on a dry fiber basis of recycled fiber;
b. producing a first ply comprising the first slurry;
c. providing a second fiber slurry comprising a second fiber composition comprising from 0%-35% by weight on a dry fiber basis of virgin fibers and from 65% to 100% by weight on a dry fiber basis of recycled fibers;
d. producing a second ply comprising the second fiber slurry; and
e. combining the first and second ply to produce a multi-ply fibrous structure.
